(19) United States
(12) Patent Application Publication
(10) Pub. No.: US 2013/0279194 A1
(43) Pub. Date: Oct. 24, 2013

(54) Light emitting systems and related methods

(71) Applicant: LITEIDEAS, LLC, Mansfield Center, CT (US)

(72) Inventors: Todd W. Hodrinsky, Mansfield Center, CT (US); Robert M. Sarazin, Marlborough, CT (US)

(73) Assignee: Liteideas, LLC, Mansfield Center, CT (US)

(21) Appl. No.: 13/867,053

(22) Filed: Apr. 20, 2013

Related U.S. Application Data
(60) Provisional application No. 61/636,694, filed on Apr. 22, 2012.

(51) Int. Cl. G02B 6/24; F21V 8/00

(52) U.S. Cl. CPC G02B 6/24; G02B 6/0065
USPC 362/612; 29/825

(57) ABSTRACT

A light-emitting system that utilizes light guides for edge lighting and back lighting applications is disclosed. A process of making the light-emitting system is also disclosed. An edge-lit thin light-emitting system can include a light guide sheet disposed between a reflector sheet and a diffuser lens sheet, at least one strip of LED arrays embedded in the optically clear material, the at least one strip is disposed on the edges of the light guide sheet with the light-emission side of LEDs facing the light guide; and, optionally, a frame disposed around the perimeter of the sheets; wherein the at least one strip of LED arrays is attached to the light guide sheet such that an air gap between the LEDs and the light guide is eliminated.

### RELATED APPLICATION DATA

This application claims the priority of prior U.S. provisional application Ser. No. 61/636,694 filed on Apr. 22, 2012, which is hereby incorporated by reference herein in its entirety.

### TECHNICAL FIELD

The invention relates to light-emitting systems and methods, and more specifically to light-emitting systems that utilize light guides for edge lighting and back lighting applications.

### BACKGROUND ART

A light emitting diode (LED) often can provide light in a more efficient manner than an incandescent light source and/or a fluorescent light source. The relatively high power efficiency associated with LEDs has created an interest in using LEDs to displace conventional light sources in a variety of lighting applications. For example, in some instances LEDs are being used as traffic lights and to illuminate cell phone keypads and displays. The light emitting devices can be used in combination with light guides for illumination purposes such as backlighting of an LCD display, for example.

A light guide is a device designed to transport light form a light source to a point at some distance with minimal loss. For that purpose, a flux from an LED must be effectively coupled to the entrance end of a light guide to allow the light to enter the light guide with minimal loss before it can be effectively transmitted and utilized. The effective flux coupling, however, is very difficult to accomplish. Consequently, the prior art light-emitting systems that utilize light guides are ineffective because a high percentage of the flux from LEDs is lost before entering the light guide. This low flux capture effectiveness of the prior art light-emitting systems is inter alia due to the air gap present between the LED and the light guide. Thus, there is a need to develop a light emitting system that utilizes a light guide, which is characterized by the improved light coupling and hence increased light intensity due to the minimized loss of flux entering the light guide.

### SUMMARY OF THE EMBODIMENTS

It is therefore an object of the present invention to provide a light-emitting system and related method of its fabrication that results in an improved flux coupling and hence increased light intensity in comparison with the light-emitting systems of the prior art.

It is further object of the present invention to provide a light-emitting system that is compact and easier to fabricate.

It is yet further object of the present invention to provide a light-emitting system and related method that is characterized by the improved waterproof, shock, and vibration resistant characteristics.

The invention features an edge-lit thin light-emitting system. The light-emitting system comprises a light guide sheet disposed between a reflector sheet and a diffuser lens sheet; at least one strip of LED arrays embedded in the optically clear material, the at least one strip is disposed on the edges of the light guide sheet with the light-emission side of LEDs facing the light guide; and, optionally, a frame disposed around the perimeter of the sheets; wherein the at least one strip of LED arrays is attached to the light guide sheet such that an air gap between the LEDs and the light guide is eliminated.

In one aspect, the optically clear material can be a silicone material.

In another aspect, the shape of the sheets and the frame is selected from the group consisting of square, oval, rectangle, triangle, or circle.

The present invention also features a backlit thin light-emitting system. The light-emitting system comprises at least one strip of LED arrays embedded in the optically clear material, the at least one strip is disposed between a reflector sheet and a light guide sheet with the light-emission side of LEDs facing the light guide; a diffuser lens sheet disposed on the light guide sheet; and, optionally, a frame disposed around the perimeter of the sheets; wherein the at least one strip of LED arrays is attached to the light guide sheet such that an air gap between the LEDs and the light guide is eliminated.

In one aspect, the optically clear material can be a silicone material.

In another aspect, the shape of the sheets and the frame is selected from the group consisting of square, oval, rectangle, triangle, or circle.

A method of making an edge-lit thin light-emitting system is disclosed. The method comprises the steps of providing a reflector sheet, disposing a light guide sheet on the reflector sheet, disposing a diffuser lens sheet on the light guide sheet, disposing at least one strip of LED arrays embedded in the optically clear material to a frame such that the non-emissive sides of LEDs are facing the frame; disposing the frame around the perimeter of the sheets such that the at least one strip of LED arrays is aligned with the light guide with the light-emission side of LEDs facing the light guide and the air gap between the LEDs and the light guide is eliminated.

In one instance, the step of disposing the frame is conducted by injecting an optically clear silicone material between the frame and the light guide sheet followed by curing the silicone material.

According to one variant, the method comprises the steps of providing a reflector sheet, disposing a light guide sheet on the reflector sheet, disposing a diffuser lens sheet on the light guide sheet, disposing at least one strip of LED arrays embedded in the optically clear material on the edges of the light guide sheet such that the at least one strip of LED arrays is aligned with the light guide with the light-emission side of LEDs facing the light guide and the air gap between the LEDs and the light guide is eliminated.

In some instances, injecting an optically clear silicone material is conducted from one side while simultaneously pulling a vacuum from another side.

In one version, the method comprises the steps of providing a reflector sheet, placing a light guide sheet on the reflector sheet, placing a diffuser lens sheet on the light guide sheet, placing at least one strip of LED arrays embedded in the optically clear material into a frame such that the non-emissive sides of LEDs are facing the frame, placing a frame around the perimeter of the sheets such that the at least one strip is aligned with the light guide with the light-emission side of LEDs facing the light guide; and attaching all of the above components together.

The attaching can be conducted by injecting an optically clear silicone material between all the components followed by curing the silicone material.

In one instance, the injecting is conducted from one side while simultaneously pulling a vacuum from another side.

A method of making a backlit thin light-emitting system in accordance with the present invention is also disclosed. The method comprises the steps of providing a reflector sheet, disposing at least one strip of LED arrays embedded in the optically clear material on the reflector sheet with the non-emissive side of LEDs facing the reflector sheet, disposing a light guide sheet on top of the reflector sheet, on the side of the reflector on which the at least one strip is disposed, disposing a diffuser lens sheet on the light guide sheet, and, optionally, disposing a frame around the perimeter of the sheets.

In one instance, the step of disposing a light guide sheet on top of the reflector is conducted by injecting an optically clear silicone material between the light guide sheet and the reflector followed by curing the silicone material.

In another instance, the injecting is conducted from one side while simultaneously pulling a vacuum from another side.

According to one example, the method comprises the steps of providing a reflector sheet, placing at least one strip of LED arrays embedded in the optically clear material on the reflector with the non-emissive side of LEDs facing the reflector sheet, placing a light guide sheet on top of the reflector sheet, on the side of the reflector on which the at least one strip is disposed, placing a diffuser lens sheet on the light guide sheet, optionally, placing a frame around the perimeter of the sheets, and attaching all of the above components together.

In one instance the step of attaching is conducted by injecting an optically clear silicone material between all the components followed by curing the silicone material.

In another variant, the injecting is conducted from one side while simultaneously pulling a vacuum from another side.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1A is an exploded view of an unassembled edgelit thin light-emitting system in accordance with one preferred embodiment of the present invention.

FIG. 1B is a front view of the system assembled from the parts as shown in FIG. 1A.

FIG. 2A is an exploded view of an unassembled backlit thin light-emitting system in accordance with another preferred embodiment of the present invention.

FIG. 2B is a front view of the system assembled from the parts as shown in FIG. 2A.

FIG. 3 is a top view of an assembled light-emitting system having a frame in accordance with one embodiment of the present invention.

FIG. 4 is an illustration of a method of making a strip of encapsulated LED in accordance with the present invention.

### DETAILED DESCRIPTION OF SPECIFIC EMBODIMENTS

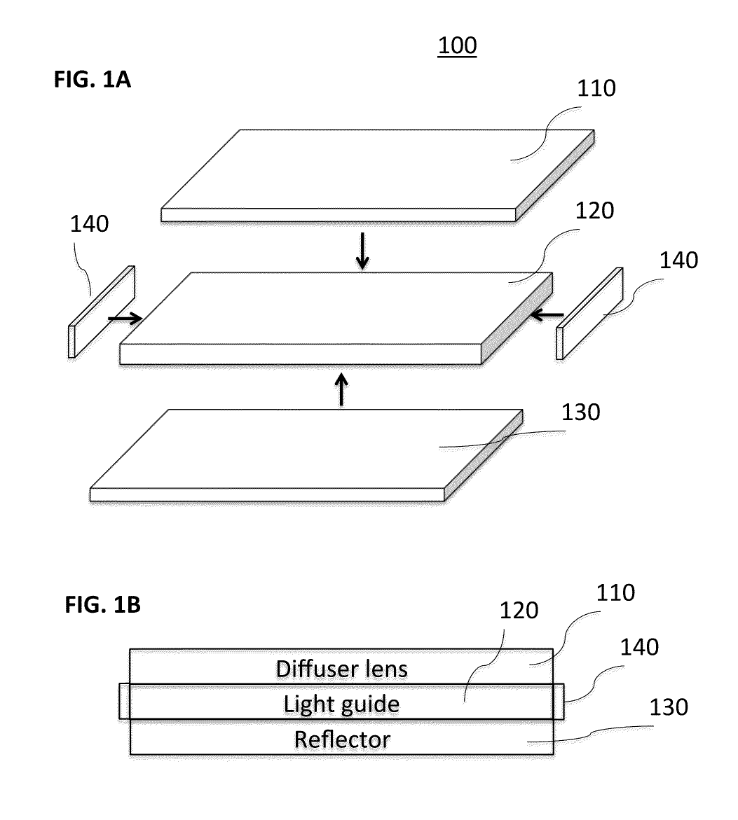

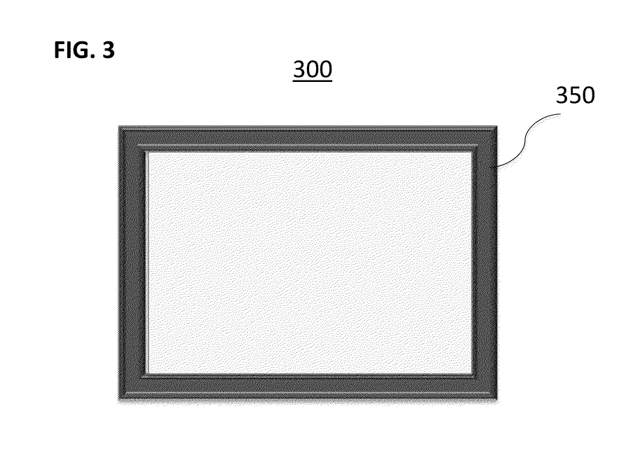

One embodiment of the present invention, as shown in FIGS. 1A and 1B, features an edge-lit thin light-emitting system (100) that comprises a light guide sheet (120) disposed between a reflector sheet (130) and a diffuser lens sheet (110), at least one strip (140) of LED arrays embedded in the optically clear material, the strip is disposed on the edges of the light guide sheet with the light-emission side of light-emitting devices facing the light guide. The strip of LED arrays is attached to the light guide sheet such that an air gap between the LEDs and the light guide is eliminated. It was surprisingly found that eliminating such air gap by bonding the strip to the light guide using an optically clear material leads to an increased light output. In some embodiments a frame (350, FIG. 3) is disposed around the perimeter of the assembly comprising the reflector, light guide, and diffuser lens sheets. The frame can be made of aluminum, steel, metal, plastic, or any other suitable material. It was also surprisingly found that eliminating any air gaps between all the components of a light-emitting system (i.e., a reflector, light guide, diffuser lens, and strip of LED arrays) by sealing the boundaries between the components with an optically clear material also leads to an improved light output and other optical characteristics of an LED system in accordance with the present invention. An optically clear material can be a silicone material, UV or temperature curable, or other optically clear materials.

There should be at least one strip of LEDs attached to the edge of a light guide (or there can be two strips of LEDs attached at the opposite edges of the light guide as shown in FIG. 1A, or it can be three strips, or four strips; or if the shape of a light guide is circular, then the strip can go around the perimeter covering some portion of the edge, or it can be more than one strip around the perimeter of the light guide). The strip of LEDs can cover some portion of the edge of the light guide or the whole portion of the edge, in longitudinal or/and latitudinal direction.

A light guide is a device designed to transport light from a light source to a point at some distance with minimal loss. Light guides that are suitable for making the system in accordance with the present invention should be made of optical grade materials such as acrylic resin, glass, polycarbonate, silicone, and epoxies. It is preferable that the light transmittance of the light guide be more than 60%.

A reflector is a device designed to reflect light. Suitable reflectors that can be utilized for making the system of the present invention can be made of silver mirrors, gold mirrors, white reflectors, or any other suitable, commercially available reflectors. It is preferable that the reflectance be more than 60%.

A diffuser lens is a device designed to spread out or scatter light. The diffuser lenses are used to achieve desired overall illumination performance in combination with a light guide. For example, the diffuser lens can be used to reduce the chance of an LCD display appearing brighter in the center than at the outer edges. The diffuser lenses suitable for realizing the system of the present invention can be made of acrylic or any other suitable and commercially available materials.

According to the present invention the shape of the components can be square, oval, rectangle, triangle, circle, or any other suitable shapes. For example, the shape of the reflector, diffuser lens, and light guide can be square, and the shape of the strip of LEDs can be rectangular. The components can be of the same size or some can have different size than the others. For example, the reflector, diffuser lens, and light guide can have the same size, and the strip of LEDs can have a different size.

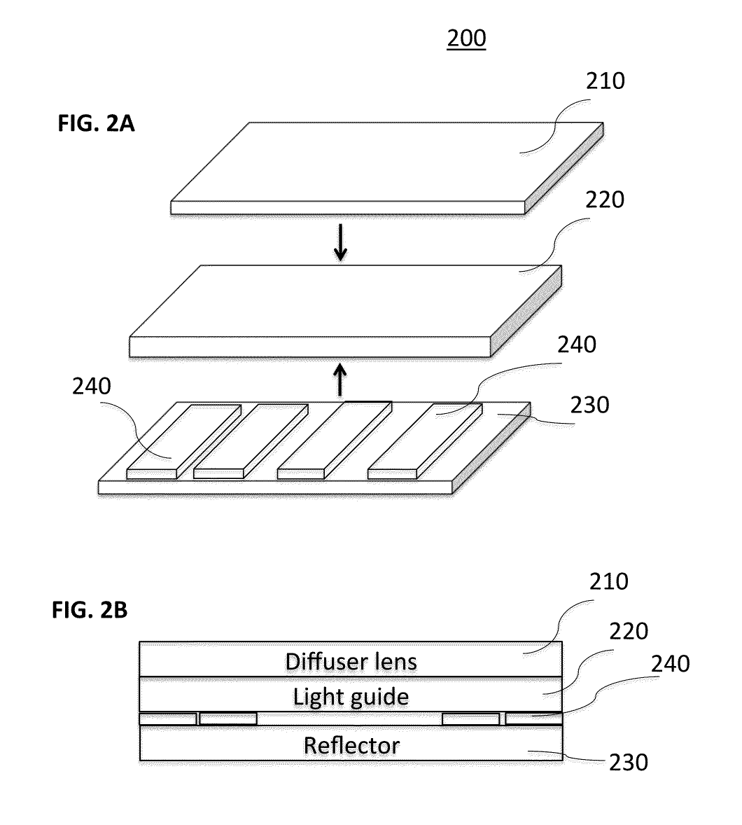

Another embodiment of the present invention as shown in FIGS. 2A and 2B features a back-lit thin light-emitting system (200) that comprises at least one strip (240) of LED arrays embedded in the optically clear material, the at least one strip is disposed between a reflector sheet (230) and a light guide sheet (220) with the light emission side of LEDs facing the light guide, a diffuser lens sheet 210) disposed on the light guide, wherein the at least one strip of LED arrays is attached to the light guide sheet such that an air gap between the LEDs and the light guide is eliminated.

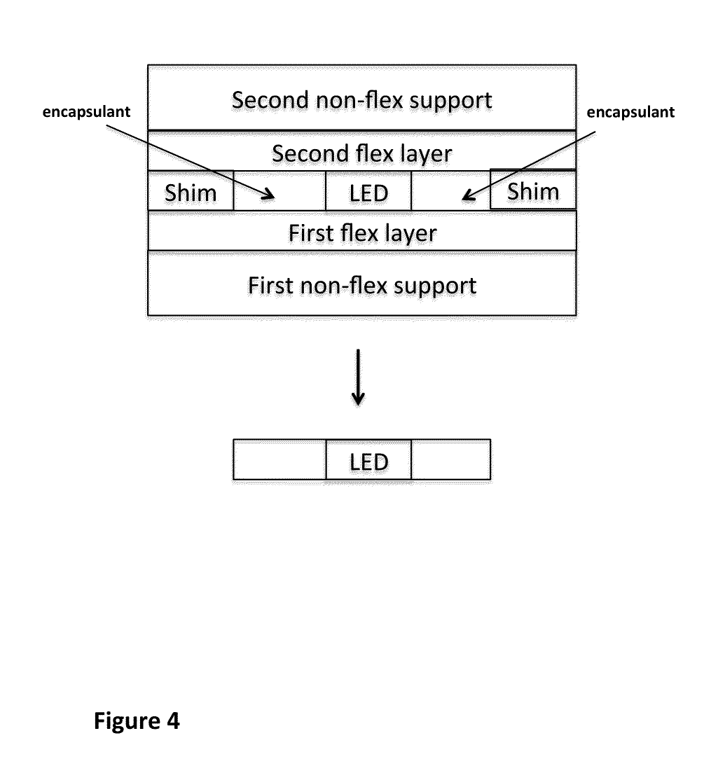

There can be at least one strip (240) having an array of LEDs embedded in an optically clear material such as silicone, or any other suitable optically clear material. The strip can cover an entire surface of the reflector (230) or it can cover some portion of the surface; there can be more than one strip (for example, two strips, or three strips, or four strips as shown in FIGS. 2A and 2B, or more than four strips, etc.). The strips can be spaced apart, or tightly packed together. The strip can be a strip of a cured optically clear material such as a silicone material, in which an array of light emitting devices is embedded. The strip can be a strip of a cured optically non-clear material in which an array of LED arrays are embedded as long as the emission surfaces of LEDs are encapsulated with optically clear material such as silicone, for example. The LEDs can further comprise lenses and light-converting materials such as phosphors. In some instances, a plurality of single light emitting devices (such as light emitting diodes) can be utilized instead of LED arrays embedded in a strip of a cured material. The strips of LED arrays can be commercially available encapsulated LEDs. In some instances, the strips can be fabricated using the process illustrated in FIG. 4 as described in this specification below.

According to the present invention the shape of the components can be square, oval, rectangle, triangle, circle, or any other suitable shapes. For example, the shape of the reflector, diffuser lens, and light guide can be square, and the shape of the strip of LEDs can be rectangular. The components can be of the same size or some can have different size than the others. For example, the reflector, diffuser lens, and light guide can have the same size, and the strip of LEDs can have a different size.

The edge-lit thin light-emitting system can be made in accordance with the present invention as follows. First, a reflector sheet is provided, then a light guide sheet is disposed on a reflector sheet. The disposing step can comprise applying an optically clear adhesive such as silicone (or any other suitable adhesives) to the surface of the reflector sheet or/and the surface of the light guide, followed by curing. The adhesive can be applied to an entire surface or to areas that are close to the edges of sheets (in case of using non-clear adhesives), or to a portion of the surface, followed by curing the adhesive using heat (if a temperature-curable adhesive is used) or using UV-light (if a UV-curable adhesive is used), or any other suitable method, depending on the type of adhesive that is being used. Then a diffuser lens sheet is disposed on the light guide sheet using an adhesive, followed by the curing step, and then at least one strip of LED arrays embedded in the optically clear material is disposed on the edges of the light guide sheet by applying an optically clear material such as silicone to the edge of the light guide or/and the strip of LED arrays, such that the strip of LED arrays is aligned with the light guide so the light-emission side of LEDs facing the light guide, followed by the step of curing an optically clear material such as silicone using heat or UV light or any other suitable method. Thus sealing the air gap between the light guide and the strip of LED arrays results in an air-free interface that is characterized by the increased light guide coupling with less light being lost, and hence by the increased light output.

It will be understood that the order of steps can be different from that which is described above. For example, the diffuser lens can be disposed on the light guide first, and then the reflector is disposed on the light guide, followed by disposing at least one strip of LED arrays to the edge of the light guide. The adhesive can be applied first to all the layers, and then cured in one step. The adhesive can be dispensed using robotic equipment, or using a syringe. In some variants of the present invention, first, all the layers are placed together, and then an optically clear adhesive, such as silicone, is injected between each component to form an air-free assembly, followed by curing the adhesive with heat, UV, or any other suitable methods. In some instances, it is preferable to pull vacuum from one side of the sheets while injecting an adhesive from another side to eliminate potential air bubbles.

In some embodiments, when a frame is used, (see frame 350, FIG. 3), the method can comprise the steps of providing a reflector sheet, disposing a light guide sheet on the reflector sheet by applying an adhesive to the surface of one or both layers, followed by curing the adhesive, disposing a diffuser lens sheet on the light guide sheet by applying an adhesive and curing it, disposing at least one strip of LED arrays embedded in the optically clear material to a frame such that the non-emissive sides of LEDs are facing the frame by applying an adhesive, followed by curing the adhesive with heat or UV, or any other suitable method, and then disposing the frame around the perimeter of the sheets such that at least one strip of LED arrays is aligned with the light guide with the light-emission side of LEDs facing the light by applying an optically clear material such as silicone to the surface of the light guide or/and surface of the strip of LED arrays.

The adhesive can be applied first to all the layers and then cured in one step, or it can be applied to several layers and then cured, and then to the remaining layers. It will be understood that the order of steps can be different from that which is described above.

In some variants of the present invention, first, all the layers are placed together, and then an optically clear adhesive, such as silicone, is injected between each component to form an air-free assembly, followed by curing the adhesive with heat, UV, or any other suitable methods. In some instances, it is preferable to pull vacuum from one side of the sheets while injecting an adhesive from another side to eliminate potential air bubbles.

A backlit thin light-emitting system can be made in accordance with the present invention as follows. First, a reflector sheet is provided, then at least one strip of LED arrays embedded in the optically clear material is disposed on the reflector sheet with the non-emissive side of LEDs facing the reflector sheet by applying an adhesive to one or both layers and curing it. Then, a light guide sheet is disposed on the reflector sheet on that side of the reflector on which the at least one strip of LEDs was disposed, using an optically clear adhesive such as silicone and curing it. A diffuser lens sheet is disposed on the light guide sheet by applying an adhesive to one or both layers and curing the adhesive. Optionally, a frame can be disposed around the perimeter of the components by applying an adhesive and curing it. The order of the steps can be different from that described above. In some instances the adhesive can be applied to all the layers and then cured in one step. In some instances, all the layers are put together first, and then an optically conductive adhesive, such as silicone, is injected between each layer, followed by the curing step using UV or heat, or any other suitable method. In some instances, it is preferable to pull vacuum from one side of the sheets while injecting an adhesive from another side to eliminate potential air bubbles. It has been surprisingly found that the resulting air-free assembly made in accordance with the preferred methods of the present invention is characterized by the increased light output or intensity. In some instances, the use of the reflector is optional for edgelit as well as for backlit configuration. In some instances, the frame can be used as a reflector for edgelit as well as for backlit configuration, wherein sidewalls of the frame are coated with a reflective coating. In some instances, a lens other than a diffuser lens can be disposed directly on a light guide.

In some embodiments, shims can be utilized to keep an encapsulant material from flowing out of the cavity.

It was surprisingly found that the process described above is fully applicable to light pipes and fiber optic light guides. For example, bonding a fiber optic light guide to a light emitter using an optically clear silicone by injecting a silicone into the boundary between two components and thereby eliminating the air gaps improves light transmission. The step of injecting a silicone can be conducted in a vacuum to eliminate air bubbles or to prevent their formation during bonding.

A strip of encapsulated LEDs can be prepared by the method illustrated in FIG. 4. A non-flexible support layer is covered with a flexible layer, then a light-emitting device (or an array of light-emitting devices) is placed on the surface of the first flexible layer, and a shim frame is placed on the surface of the flexible layer (on the perimeter of the flexible layer). The height of the shim frame is being about equal to the height of the light-emitting device. Then another flexible layer is placed on top of the shim frame as shown in FIG. 1, and another non-flexible support layer is placed on top of the flexible layer. The layers are clamped together with clamps in at least two places, followed by an encapsulant injection into the cavity formed between the first and the second flexible layers. The injection of the encapsulant is conducted by means of syringe or similar dispensing device. The encapsulant material is then cured. Depending on the type of an encapsulant material chosen, it can be cured by application of temperature, UV light, sunlight, or any other similar means. After the encapsulant material has been cured, the top non-flexible support layer and flexible layer are removed by pealing them off. The shim frame can be optionally removed. It could be pealed off, or cut off around the perimeter with a cutting device such as a razor, knife, or similar cutting devices. Then the bottom non-flexible support layer and flexible layers are removed and conductive patterns are formed on the encapsulant to create a circuit in electrical communication with the n-contact layer and p-contact layer of the light-emitting device for connecting to a AC or DC power source. The shim frame could be made of metal, plastic, or any other suitable material. The light-emitting device can be placed on the carrier manually, or using pick-and-place robotic systems, or by any other suitable methods. The conductive pattern/circuitry on the carrier can be formed by application of a conductive coating, a conductive ink, or a conductive adhesive, using a printing method such as inkjet printing method, a laser printing method, a silk-screen printing method, and a base sheet printing method, or any other suitable similar method.

The non-flexible support layer can be made of copper, glass, steel, plastic, or other metals or rigid materials that are suitable for forming a non-flexible support layer.

The flexible layer can be made of PET, PSA, or PMMA. It can be coated or sprayed on the non-flexible support layer. Both the flexible layer and non-flexible layer are formulated to transmit UV light, when a UV-curable encapsulant is used.

The encapsulant can be chosen from temperature curable or UV-curable silicones, polyurethanes, epoxies, cyanoacrylates and acrylics, or mixture thereof. It can be formulated to have different hardness, to stick or not stick to flexible layer and to non-flexible support layer, or be thermally moldable. When an encapsulant is formulated not to stick to flexible layer, it functions as a release layer to provide for ease of removal of non-flexible support layer along with flexible layer. The top and bottom sides of the light-emitting device are exposed, i.e. not encapsulated, which allows for formation of conductive patterns being in electrical communication with the p-contact and n-contact of the light-emitting device. The described-above encapsulation steps can be repeated to form additional encapsulation layers on the top, or bottom, or both sides of the light-emitting system. For example, a shim frame can be placed on the top side and then a flexible layer and non-flexible support layer are placed thereon as well, followed by injecting an encapsulant (such as optically clear silicone) into the cavity and curing the encapsulant, and then removing the non-flexible support layer along with the flexible layer. The thickness of the encapsulation layer is determined by the thickness of the shim frame. This process can be applied to both sides of the light-emitting system. For ease of injection of an encapsulant material, cavities in the non-flexible support layers are formed as shown in FIG. 3 to form an opening for injecting an encapsulant through the opening. A shim frame can have a discontinuity as well so when aligned and clamped together even bigger opening is formed. There can be more than one opening formed using this approach. The vacuum can be pulled from one side of the frame while injecting an encapsulant from another side to prevent formation of air bubbles.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An edge-lit thin light-emitting system comprising:
a light guide sheet disposed between a reflector sheet and a diffuser lens sheet;
at least one strip of LED arrays embedded in the optically clear material, said at least one strip is disposed on the edges of said light guide sheet with the light-emission side of LEDs facing the light guide; and, optionally, a frame disposed around the perimeter of said sheets;
wherein the at least one strip of LED arrays is attached to the light guide sheet such that an air gap between the LEDs and the light guide is eliminated.

2. A back-lit thin light-emitting system comprising:
at least one strip of LED arrays embedded in the optically clear material, said at least one strip is disposed between a reflector sheet and a light guide sheet with the light-emission side of LEDs facing the light guide; a diffuser lens sheet disposed on said light guide sheet; and,
optionally, a frame disposed around the perimeter of said sheets; wherein the at least one strip of LED arrays is attached to the light guide sheet such that an air gap between the LEDs and the light guide is eliminated.

3. A system according to claim 1, wherein the optically clear material is silicone.

4. A system according to claim 2, wherein the optically clear material is silicone.

5. A system according to claim 1, wherein the shape of the sheets and the frame is selected from the group consisting of square, oval, rectangle, triangle, and circle.

6. A system according to claim 2, wherein the shape of the sheets and the frame is selected from the group consisting of square, oval, rectangle, triangle, and circle.

7. A method of making a system of claim 1, said method comprising:
providing a reflector sheet;
disposing a light guide sheet on the reflector sheet;
disposing a diffuser lens sheet on the light guide sheet;
disposing at least one strip of LED arrays embedded in the optically clear material to a frame such that the non-emissive sides of LEDs are facing the frame;
disposing the frame around the perimeter of the sheets such that the at least one strip of LED arrays is aligned with the light guide with the light-emission side of LEDs facing the light guide and the air gap between the LEDs and the light guide is eliminated.

8. A method of making a system of claim 1, said method comprising:
providing a reflector sheet;
disposing a light guide sheet on the reflector sheet;
disposing a diffuser lens sheet on the light guide sheet;
disposing at least one strip of LED arrays embedded in the optically clear material on the edges of the light guide sheet such that the at least one strip of LED arrays is aligned with the light guide with the light-emission side of LEDs facing the light guide and the air gap between the LEDs and the light guide is eliminated.

9. A method according to claim 7, wherein the step of disposing the frame is conducted by injecting an optically clear silicone material between the frame and the light guide sheet followed by curing the silicone material.

10. A method according to claim 7, wherein injecting an optically clear silicone material is conducted from one side while simultaneously pulling a vacuum from another side.

11. A method according to claim 8, wherein injecting an optically clear silicone material is conducted from one side while simultaneously pulling a vacuum from another side.

12. A method of making a system of claim 1, said method comprising:
providing a reflector sheet;
placing a light guide sheet on the reflector sheet;
placing a diffuser lens sheet on the light guide sheet;
placing at least one strip of LED arrays embedded in the optically clear material into a frame such that the non-emissive sides of LEDs are facing the frame;
placing a frame around the perimeter of the sheets such that the at least one strip is aligned with the light guide with the light-emission side of LEDs facing the light guide; and
attaching all of the above components together.

13. A method according to claim 12, wherein attaching is conducted by injecting an optically clear silicone material between all the components followed by curing the silicone material.

14. A method according to claim 13, wherein the injecting is conducted from one side while simultaneously pulling a vacuum from another side.

15. A method of making a system of claim 2, said method comprising:
providing a reflector sheet;
disposing at least one strip of LED arrays embedded in the optically clear material on the reflector sheet with the non-emissive side of LEDs facing the reflector sheet;
disposing a light guide sheet on top of the reflector sheet, on the side of the reflector on which the at least one strip is disposed;
disposing a diffuser lens sheet on the light guide sheet; and, optionally, disposing a frame around the perimeter of the sheets.

16. A method according to claim 15, wherein the step of disposing a light guide sheet on top of the reflector is conducted by injecting an optically clear silicone material between the light guide sheet and the reflector followed by curing the silicone material.

17. A method according to claim 16, wherein the injecting is conducted from one side while simultaneously pulling a vacuum from another side.

18. A method of making a system of claim 2, said method comprising:
providing a reflector sheet;
placing at least one strip of LED arrays embedded in the optically clear material on the reflector with the non-emissive side of LEDs facing the reflector sheet;
placing a light guide sheet on top of the reflector sheet, on the side of the reflector on which the at least one strip is disposed;
placing a diffuser lens sheet on the light guide sheet;
optionally, placing a frame around the perimeter of the sheets; and
attaching all of the above components together.

19. A method according to claim 18, wherein attaching is conducted by injecting an optically clear silicone material between all the components followed by curing the silicone material.

20. A method according to claim 19, wherein the injecting is conducted from one side while simultaneously pulling a vacuum from another side.
